(19) United States
(12) Patent Application Publication
(10) Pub. No.: US 2007/0201732 A1
(43) Pub. Date: Aug. 30, 2007

(54) APPARATUSES, METHODS AND COMPUTER PROGRAMS FOR ARTIFICIAL RESOLUTION ENHANCEMENT IN OPTICAL SYSTEMS

(76) Inventor: Mikael Wahlsten, Stockholm (SE)

Correspondence Address: HARNESS, DICKEY & PIERCE, P.L.C., P.O. BOX 8910, RESTON, VA, 20195, US

(21) Appl. No.: 11/623,174

(22) Filed: Jan. 15, 2007

Related U.S. Application Data
(60) Provisional application No. 60/758,533, filed on Jan. 13, 2006.

(51) Int. Cl. G06T 7/00

(52) U.S. Cl. 382/120

(57) ABSTRACT

In a method for measuring lithographic features on a surface with an optical system, a laser beam is scanned over lithographic features on the surface and the laser beam is reflected or transmitted. An image of the lithographic features is formed by the reflected or transmitted laser beam. The image is filtered using a filter, which is an inverse convolution based on a kernel representing the optical system. The filtering provides a threshold that is equal for all line widths and provides the same relative difference from the nominal critical dimension for all line widths. The surface is a wafer or a work piece.

### PRIORITY STATEMENT

This non-provisional U.S. patent application claims priority under 35 U.S.C. § 119(e) to provisional application No. 60/758,533, filed on Jan. 13, 2006, the entire contents of which are incorporated herein by reference.

### BACKGROUND

Metrology equipment with sufficient accuracy is fundamental in fabricating masks for thin-film-transistors (TFTs). Conventionally, metrology systems having a registration performance below about 100 nm (3σ) can measure line width associated with both larger (e.g., greater than 2 microns) and smaller (e.g., less than 2 microns) structures. When measuring larger structures, higher resolution may not be required. However, when measuring smaller structures, higher resolution may be needed to maintain correct measurement of the line width.

In an example conventional method, a conventional optical system may be used to capture a 3D intensity image. An intensity threshold may be applied to the 3D intensity image to create a two-dimensional (2D) image. Methods for generating a 2D image by applying a threshold to a 3D intensity image are well-known in the art, and thus, a detailed discussion will be committed for the sake of brevity. Using the conventional optical system, both position and line width may be measured according to the generated 2D image.

In the above-described process, the well-known z-correction may be used to reduce effects of plate distortion, improve overlay and/or registration by eliminating plate distortion caused by uneven substrate backsides, contamination, etc. However, conventional optical systems have limited resolution because as line width decreases, the required threshold for providing a correct critical dimension (CD) must be decreased.

A resolution limit of an optical measurement system may be described as the smallest line width satisfying a given linearity specification. Ultimately, the resolution of an optical measurement system is defined by the wavelength (λ) used in the optical system. Resolution of the measurement system may be improved, for example, by increasing the effective numerical aperture (NA) and/or choosing a laser having a shorter wavelength (λ).

However, to increase the effective NA, the optical system may require more advanced optics and/or more advanced data handling, which may result in the system becoming more sensitive to focus variations. To use a laser having a shorter wavelength (λ), the optical system may need to be adapted to accommodate the shorter wavelength. This may result in a more complicated optical system. In addition, these conventional methods for increasing resolution may not be cost effective.

FIG. 4 is a graph showing the relationship between the intensity of a line and the distance between the rising and falling edge of the reflex signal. As shown, at a 3 micron line width, the signal begins to fall after reaching a local maximum intensity. The local maximum intensity serves as the above-described intensity threshold. However, as the line width decreases to 2 microns, and then to 1 micron, the distance between the rising edge and the falling edge of the reflex signal decreases and the signal intensity does not reach the same maximum local intensity. Thus, in order to detect these smaller line widths, the threshold may need to be decreased. Decreasing such a threshold, however, may increase the possibility of false line detection and/or provide a larger critical dimension (CD) for thicker lines, each of which may be undesirable.

### SUMMARY

Example embodiments of the present invention may increase (e.g., artificially increase) optical resolution of an optical system (e.g., an incoherent optical system), which may provide increased linearity, be more cost effective and/or decrease measurement time. At least some example embodiments of the present invention may be more cost effective to implement, and/or used selectively based upon need. In addition, at least some example embodiments of the present invention may be independent of pattern orientation and/or pattern topology, and therefore, may be generic and/or be applicable to any optical system. In at least some example embodiments of the present invention, the calculation time may be independent of the pattern density in a scanned image. At least some example embodiments of the present invention provide the ability to decrease optical resolution, while increasing signal to noise ratio, and vice-versa. Example embodiments of the present invention may also, or alternatively, be easier to calibrate.

At least one example embodiment provides a method for improving optical resolution. According to at least this example embodiment, a three-dimensional intensity image for an object to be measured may be generated, and a filter may be constructed using a mathematical model of an optical system. The intensity image may be filtered using the constructed filter, and the three-dimensional intensity image may be converted into a two-dimensional image to be measured.

According to at least some example embodiments, the three-dimensional intensity image may be generated based on image data gathered by the optical system. The filter may be constructed by generating at least one threshold value based on the gathered image data, estimating a point spread function based on the gathered image data and the at least one threshold, constructing the filter based on the estimated point spread function and the image data, and calibrating the constructed filter.

According to at least some example embodiments, the filter calibration may further include filtering a first portion of the image data to generate a first filtered data, measuring the linearity of the first filtered data, determining whether the linearity of the first filtered data passes a linearity threshold, and re-calibrating the constructed filter if the first filtered data does not pass the linearity threshold. If the linearity of the first filtered data passes the linearity threshold, the filter calibration may include determining whether the constructed filter is calibrated properly. The image data may be filtered using the constructed filter if the constructed filter is calibrated properly.

According to at least some example embodiments, the constructed filter may be determined to be calibrated properly by filtering a second portion of the image data to generate a second filtered data, and comparing the second filtered data with a filter threshold. The constructed filter may have been calibrated properly if the second filtered data passes the filter threshold. The constructed filter may be an inverse filter.

At least one other example embodiment provides a method for measuring lithographic features on a surface of an object. According to at least this example embodiment, an illumination optical beam may be impinged over lithographic features on the surface, and an image of the lithographic features may be formed. The image may be created using the illumination optical beam. The image may be filtered using a filter, which is an inverse convolution based on a kernel representing the optical system.

According to at least some example embodiments, the filtering may provide a threshold that is equal for all line widths and provides the same relative difference from the nominal critical dimension for all line widths. The surface may be a wafer or a work piece. The illumination optical beam may be reflected on and/or transmitted through the surface. The image may be recorded on an image sensor, which may be at least one CCD camera or at least one CMOS camera. The illumination optical beam may be scanned over the lithographic features on the surface. There may be essentially no relative motion between the image sensor and the surface. The illumination optical beam may be a laser beam. The image may be created by at least one flash of the illumination optical beam over the lithographic features on said surface.

At least one other example embodiment provides an apparatus including an optical system and a computer. The optical system may be configured to generate a three-dimension intensity image for an object to be measured. The computer may be configured to construct a filter using a mathematical model of the optical system, filter the intensity image using the constructed filter and convert the three-dimensional intensity image into two-dimensional image to be measured.

According to at least some example embodiments, the optical system may be further configured to gather image data associated with the object to be measured and generate the three-dimensional intensity image based on the gathered image data. The computer may generate at least one threshold value based on the gathered image data, estimate a point spread function based on the gathered image data and the at least one threshold, construct the filter based on the estimated point spread function and the image data, and calibrate the constructed filter. The computer may be configured to calibrate the filter by filtering a first portion of the image data to generate a first filtered data, measuring the linearity of the first filtered data, determining whether the linearity of the first filtered data passes a linearity threshold, and re-calibrating the constructed filter if the first filtered data does not pass the linearity threshold. If the linearity of the first filtered data passes the linearity threshold, the computer may determine whether the constructed filter is calibrated properly, and filter the image data using the constructed filter if the constructed filter is determined to be calibrated properly.

According to at least some example embodiments, the computer may determine whether the constructed filter is calibrated properly by filtering a second portion of the image data to generate a second filtered data, and comparing the second filtered data with a filter threshold. The constructed filter may be determined to be calibrated properly if the second filtered data passes the filter threshold. The constructed filter may be an inverse filter.

At least one other example embodiment provides an apparatus for measuring lithographic features on a surface of an object. The apparatus may include an optical system and a computer. The optical system may be configured to impinge an illumination optical beam over lithographic features on the surface to form an image of the lithographic features. The image may be created using the illumination optical beam. The computer may be configured to filter the image using a filter. The filter may be an inverse convolution based on a kernel representing the optical system.

According to at least some example embodiments, the computer may be configured to provide a threshold that is equal for all line widths and provides the same relative difference from the nominal critical dimension for all line widths. The optical system may include an image sensor, and the image sensor may be configured to record the image.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates an optical system according to an example embodiment;

FIG. 2 is an example of a 3D intensity image generated based on data gathered by the conventional optical system of FIG. 1;

FIG. 3 is an example of a 2D image generated by thresholding the 3D intensity image of FIG. 2;

FIG. 4 is a graph showing the relationship between intensity and distance between the rising and falling edge of a reflex signal for decreasing line widths;

FIG. 5 is a flow chart illustrating a method for enhancing resolution of an optical system, according to an example embodiment of the present invention;

FIG. 6 is a flow chart illustrating a method for constructing a filter, according to an example embodiment of the present invention;

FIG. 7 is a flow chart illustrating a filtering method, according to an example embodiment of the present invention; and

FIG. 8 illustrates another optical system, according to an example embodiment.

### DETAILED DESCRIPTION OF EXAMPLE EMBODIMENTS

Example embodiments of the present invention may increase or enhance (e.g., artificially increase or enhance) resolution of an optical system.

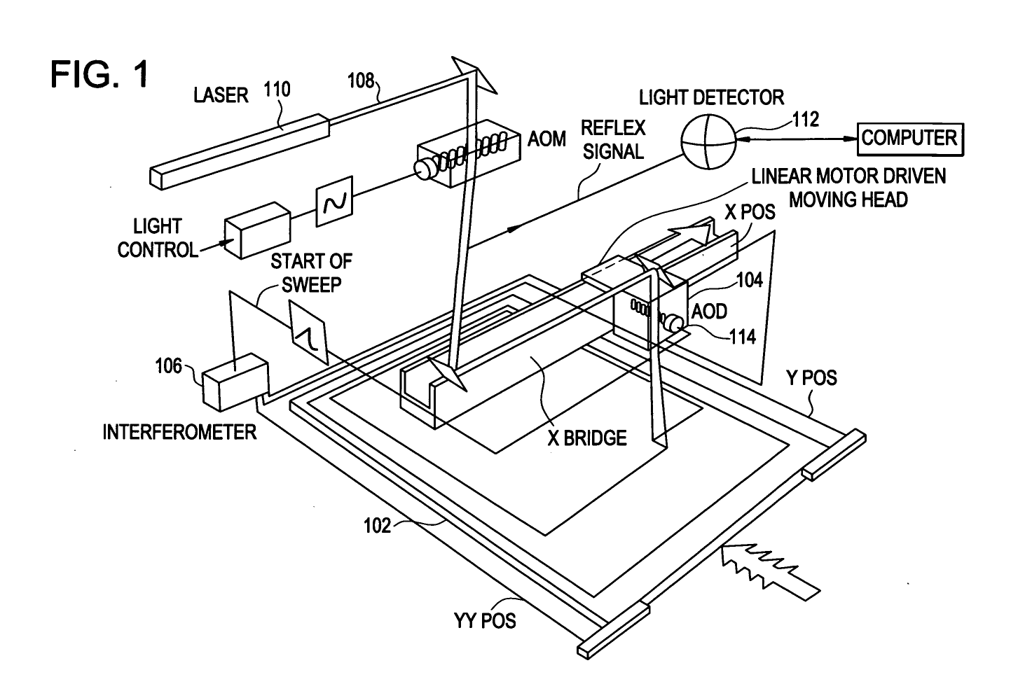

FIG. 1 is a perspective view of an optical system, according to an example embodiment. The optical system of FIG. 1 may be capable of measuring masks having maximum dimensions of about 1300 mm by about 1500 mm. As shown, the optical system may include a substrate stage 102 capable of moving in a first direction (e.g., the y-direction) and an optical head 104 capable of moving in a second direction (e.g., the x-direction). The first direction may be perpendicular to the second direction. The movement and/or positioning of the stage 102 and optical head 104 may be controlled by an interferometer 106.

In example operation, a laser beam scan may be created by deflecting a laser beam generated by a laser 110 using an acousto-optic deflector (AOD) 114. After deflecting the laser beam using the AOD 114, the measurement beam may be focused on the plate by a 4 mm lens (not shown) having a numerical aperture (NA) of about 0.55 nm. The focus of the beam may be controlled by an advanced flow focus system (not shown). The focus stability may be kept within +/− about 50 nm.

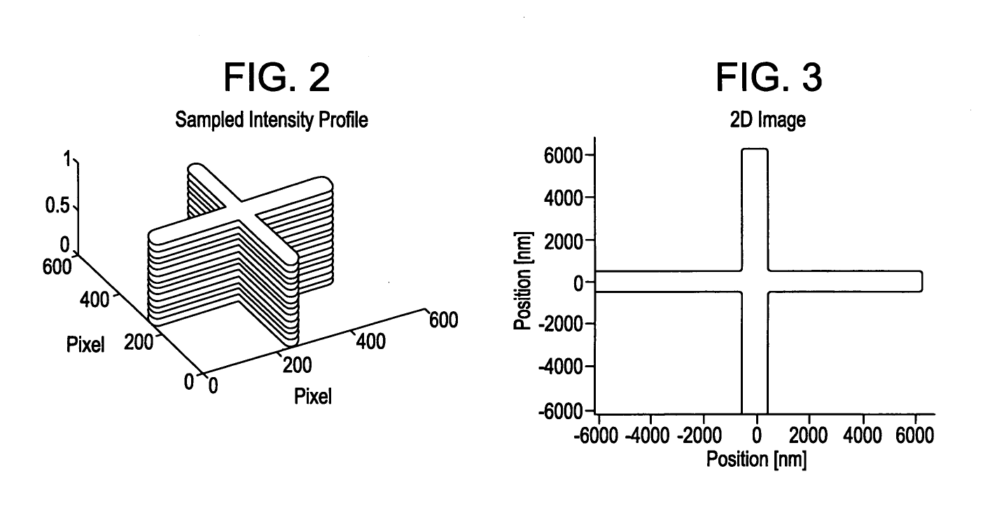

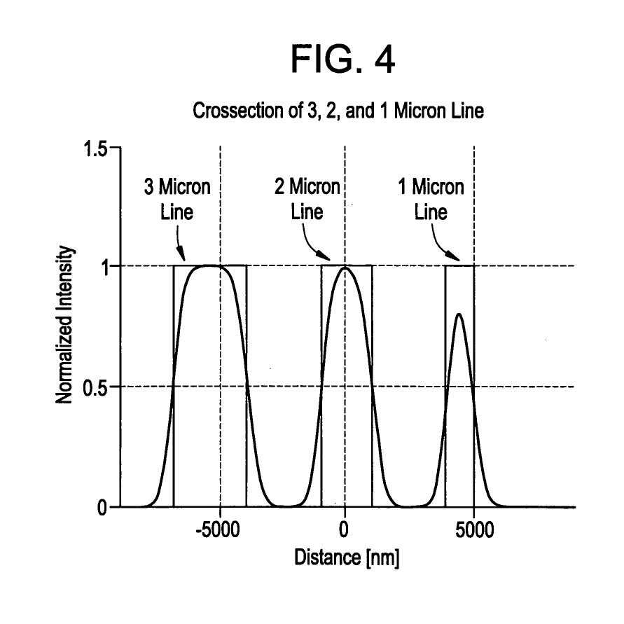

A CCD camera (not shown) mounted on the optical head 104 may be used to locate the measurement objects prior to measurement, and an object or structure may be measured by irradiating the scanning laser beam 108 at the structure or object, and measuring the reflected light (e.g., the reflex signal) using a light detector 112. That is, for example, the reflected light may be sampled by a light detector 112 connected to a high speed A/D converter. The deflection may be synchronized with the x-position of the measurement head 104 to generate a three-dimensional (3D) intensity image of the measured object. The information or data, for example, the 3D intensity image, may be output to a computer 116. The computer 116 in FIG. 1 may control and/or administer the optical system shown in FIG. 1. An example 3D intensity image is shown in FIG. 2.

An intensity threshold may be applied to the 3D intensity image to create a two-dimensional (2D) image. Methods for generating a 2D image by applying a threshold to a 3D intensity image are well-known in the art, and thus, a detailed discussion will be omitted for the sake of brevity. An example 2D image corresponding to the 3D intensity image shown in FIG. 2 is shown in FIG. 3.

According to example embodiments of the present invention, the resolution of an optical system may be artificially increased using a mathematical model of the optical system. The mathematical model also know as a “kernel” may be used to construct a filter (e.g., an inverse filter), which may be applied to a 3D intensity image (e.g., a 3D intensity data file, such as, a MEG-file) generated based on 3D object data gathered using the optical system. The 3D intensity image may be filtered before converting the 3D intensity image to a 2D image (e.g., DPX-file) for measurement.

Method for filtering 3D intensity images (e.g., constructing a 2D image) are well-known in the art, and therefore, only a brief discussion of one example method will be provided herein. However, it will be understood that example embodiments of the present invention may be implemented in conjunction with any known filtering method.

An example manner in which a mathematical model may be created will be discussed in detail below. For the sake of clarity, the point spread function (PSF) will be assumed to be rotation symmetric, and thus, PSF(dx,dy)=PSF(−dx,−dy). However, it will be understood that example embodiments of the present invention may be equally applicable to any method for mathematically modeling an optical system.

In one example, the wavelength λ and the NA of the optical system may be used to determine the radius of a point spread function (PSF) for the optical system. If a linearity condition (e.g., if a linear increase of the intensity in the object plane gives a linear response in the image plane) and a space invariant condition (e.g., a translation in the x/y-object plane gives rise to a linear translation in the image plane) are satisfied, the image may be described with a convolution, such as equation 1):

$$Image ( x , y ) = {\int }_{dx} {\int }_{dy} Object ( x - dx , y - dy ) \cdot PSF ( dx , dy ) ⅆ x ⅆ y = Object ( x , y ) * PSF ( x , y ) \qquad ( 1 )$$

The linearity condition and the space invariant condition may be fulfilled in an ideal, aberration-free optical system. However, example embodiments are applicable to non-aberration-free optical systems. For example, an error budget for optical aberrations in a realistic or actual optical system may be created according to a required performance for the measurement system. Using the error budget, equation (1) may provide a satisfactory (or alternatively an acceptable) approximation of Image(x,y).

To model a sweep measurement optical system, such as is the case with the optical system of FIG. 1, equation (1) may be rewritten as equation (2):

$$Image ( x , y ) = {\int }_{dx} {\int }_{dy} Object ( x + dx , y + dy ) \cdot PSF ( dx , dy ) ⅆ x ⅆ y \qquad ( 2 )$$

According to equation (2), all light in pixel (x,y) is reflected light when the spot function is centered above the object at position (x,y). When equation (1) is rewritten as equation (2), dx and dy change sign, and thus, equation (2) may be rewritten as equation (3):

$$Image ( x , y ) = {\int }_{dx} {\int }_{dy} Object ( x - dx , y - dy ) \cdot PSF ( - dx , - dy ) ⅆ x ⅆ y \qquad ( 3 )$$

Combining equations (1) and (3), we arrive at equation (4) for describing an image captured by the optical system:

$$Image ( x , y ) = {\int }_{dx} {\int }_{dy} Object ( x - dx , y - dy ) \cdot PSF ( - dx , - dy ) ⅆ x ⅆ y = Object ( x , y ) * PSF ( x , y ) \qquad ( 4 )$$

In a conventional optical system, equation (4) may be applied directly without assuming that PSF(x,y)=PSF(−x,−y) because the light detector has a spatial resolution. In a coherent optical system the PSF function may be an imaginary function to allow the phase of the light to play a role (e.g., a relatively significant role) in creating the final image at the detector. In this case, the PSF may be an imaginary function allowing the phase of the light play a more important role when the final image at the detector is created.

For the sake of clarity and brevity, as discussed herein, however, it is assumed that PSF(dx,dy)=PSF(−dx,−dy). However, the above-described equation (4) is applicable to both conventional and coherent conventional optical systems in at least the above-described manner.

As is well-known in the art, a convolution in the space domain corresponds to a multiplication in the frequency domain. Therefore, equation (4) can be rewritten in the frequency domain as equation (5), which represents a mathematical model or kernel for the optical system of FIG. 1:

$$𝔍 ( Image ( x , y ) = 𝔍 ( Object ( x , y ) ) \cdot 𝔍 ( PSF ( x , y ) ) ⇒ \\ 𝔍 ( Object ( x , y ) ) = \frac{𝔍 ( Image ( x , y )}{𝔍 ( PSF ( x , y ) )} \qquad ( 5 )$$

In equation (5), □□ is a Fourier operator and □□(PSF(x,y)) is the optical transfer function (OTF) for the optical system. Because the power spectrum of the OTF as a function of spatial frequency has a negative slope, higher frequency noise may be magnified more than lower frequencies. In order to control the amplification of the noise a second factor

$$\frac{\vert 𝔍 ( PSF ( x , y ) ) \vert}{\vert 𝔍 ( PSF ( x , y ) ) \vert + K ( x , y )}$$

may be added to the filter. K(x, y) in the second factor may determine the maximum amplification of the filter.

The mathematical model of the optical system as shown in equation (5) in combination with the factor

$$\frac{\vert 𝔍 ( PSF ( x , y ) ) \vert}{\vert 𝔍 ( PSF ( x , y ) ) \vert + K ( x , y )}$$

may be used to construct a filter, according to an example embodiment of the present invention, as shown in equation (6).

$$Filter = h ( x , y ) = \frac{1}{𝔍 ( PSF ( x , y )} \cdot \frac{\vert 𝔍 ( PSF ( x , y ) ) \vert}{\vert 𝔍 ( PSF ( x , y ) ) \vert + K ( x , y )} \qquad ( 6 )$$

The filter described in equation (6) may also be referred to as an inverse convolution based on a kernel (e.g., a PSF) representing the optical system.

The K value K(x, y) in the second factor may determine the maximum amplification of the filter. In other words, K(x,y) is a factor used to limit amplification of the filter. Limiting amplification of the filter may be needed to provide a desired or specific signal to noise ratio (SNR) in the final image. In the spatial frequency domain, for example, K(fx,fy) (x→fx, and y→fy in the spatial frequency domain) may be described as a matrix with different scalar values for different spatial frequencies (fx,fy). These scalar values may be chosen prior to optimization to provide such an SNR in the image after filtering. Alternatively, the scalar values may be part of the optimization. In this alternative case, the optimization may be referred to an optimization under a constraint for K(x,y) in order to maintain an acceptable signal to noise level in the final image after filtering. Each of independent parameters K(x,y) and PSF(x,y) may be required to construct the filter. These parameters may be estimated during a calibration sequence using given calibration patterns with known sizes. The calibration method may be any suitable calibration method as is well-known in the art. An example method for calibration is described, for example, in U.S. Patent Publication No. 2005/0086820, the entire contents of which are incorporated herein by reference. For example, the parameters K(x,y) and PSF(x,y) may be calculated by solving an optimization problem, for example, as shown in equation (7):

$$Min {\sum }_{n} \vert {CD}_{ref} ( n ) - {CD}_{measured} ( n , PSF ( x , y ) , K ( x , y ) ) \vert \qquad ( 7 )$$

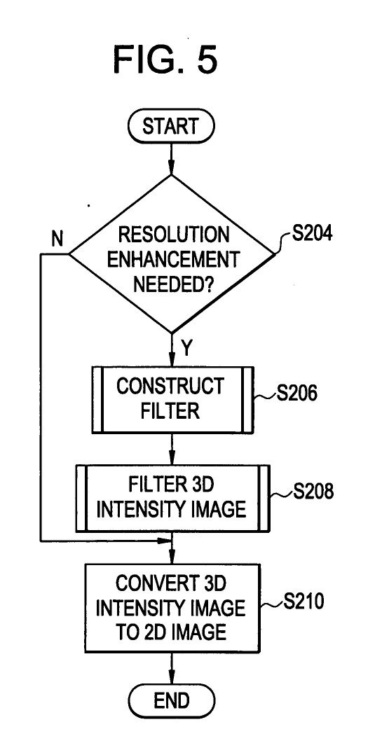

FIG. 5 is a flow chart illustrating a method for enhancing resolution of an optical system, according to an example embodiment of the present invention. The method of FIG. 5 may be implemented in the form of hardware, software or a combination thereof. For example, the resolution enhancement method may be implemented in the form of software run on a computer, for example, computer 116 connected to, and administering, the optical system of FIG. 1.

Referring to FIG. 5, after generating a 3D intensity image using object data gathered by the optical system of FIG. 1, the optical system may determine whether resolution enhancement is needed at S204. The object data may be gathered by the optical system by scanning a laser beam over lithographic features on a surface of a wafer or work piece and detecting the reflectance and/or transmittance of the laser beam. An image of lithographic features may then be generated using the collected image data. This method of generating a 3D intensity image is well-known in the art, and thus, a further explanation will be omitted for the sake of brevity.

Referring back to S204, whether resolution enhancement is needed at S204 may be determined by a human operator, or by a computer algorithm based on, for example, the size of the object being measured. For example, if the object is a smaller object (e.g., less than or equal to 2 microns), then resolution enhancement may be needed. If the object is a larger object (e.g., greater than 2 microns), then resolution enhancement may not be needed. In at least one example embodiment of the present invention, the size of the measured object may be compared with a threshold (e.g., 2 microns). If the measured object is greater than 2 microns, resolution enhancement may not be needed. If the measured object is less than or equal to 2 microns, then resolution may be needed.

If resolution enhancement is not needed, the system may convert the 3D intensity image into a 2D image, for example, using a thresholding operation, at S210, and output the 2D image for measurement. The conversion from the 3D intensity image to a 2D image performed at S210 is well-known in the art, and therefore, a detailed description thereof will be omitted for the sake of brevity.

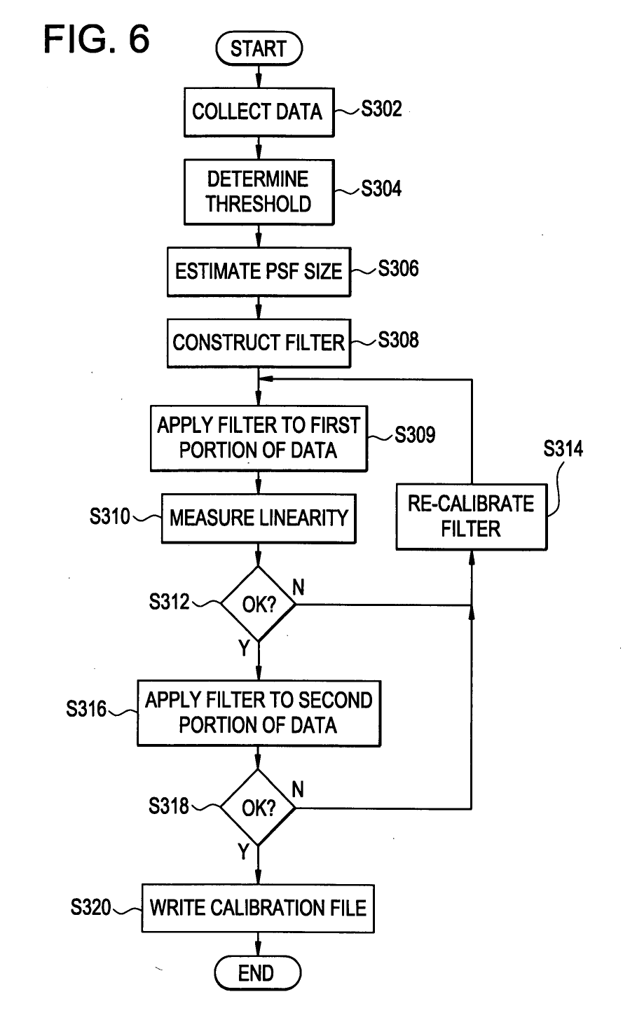

Returning to S204, if the system determines that resolution enhancement is needed, a filter for filtering the image may be constructed at S206. A method for constructing a filter, according to an example embodiment of the present invention, is shown in FIG. 6, and will be discussed in more detail below.

Referring to FIG. 6, a method for constructing a filter, according to an example embodiment of the present invention, may include creating a calibration file (e.g., a tab formatted ASCII file) with information regarding a k-matrix, spot radius, rotation angle of a spot and thresholds for isolated large x and y features for both positive and negative polarities. The spot radius may be a spot radius (1/e²) in an x and y direction.

As shown in FIG. 6, at S302, data may be gathered from bridge align (BA) marks. BA marks are registration marks attached to a glass stage having, for example, a relatively small (e.g., near-zero) coefficient of thermal expansion and/or excellent thermal shock resistance. BA marks may hold a set of different patterns with known positions and CD. In at least one example embodiment of the present invention, the size of the object may be about 0.5 μm to about 2 μm. In measuring the object, the object may be in the form of raster lines in both the x and y directions. The lines may include single and/or dense lines. In addition, 45 and 135 degree rasters may be measured in order to estimate the rotation angle of the spot. Large isolated x and y lines may be measured in both polarities for use in estimating a threshold.

At S304, at least one intensity threshold may be determined. For example, the 3D intensity image containing large isolated x and y lines in both polarities may be used in calculating four thresholds threshXclear, threshYclear, threshXdark and threshYdark. Thresholds threshXclear and threshYclear represent thresholds for determining whether a respective point or pixel in the 3D intensity image is clear, whereas the thresholds threshXdark and threshYdark represent thresholds for determining whether a respective point or pixel in the 3D intensity image is dark. The mean of these four thresholds may be used as a global threshold threshglobal. The thresholds threshXclear, threshYclear, threshXdark, threshYdark and threshglobal may be stored in the calibration file. Any or all of these thresholds may be used as a threshold for converting the 3D intensity image into a 2D image.

At S306, data collected at S302 may be used in calculating linearity curves for isolated x and y lines for both polarities. For example, the linearity curves may be calculated by subtracting a measured critical dimension (CD) value from a nominal CD value stored in a database. The measured CD value may be obtained by measuring the lines in a measurement machine with a relatively high resolution (e.g., a resolution higher than the optical system discussed herein), and thus, will be treated herein as known values. If the calculated linearity curves have a given dropout width, the PSF may be estimated using linear interpolation and the following equation (7).
PSF 1/e²=PSF_{—}W_MIN+0.5(PSF_{—}W_MAX−PSF_{—}W_MIN) (8)

In Equation (8), PSF_W_MIN may be a known PSF corresponding to a drop out width closest to, but not larger than a drop out width stored in the database. PSF_W_MAX may be a PSF corresponding to a drop out width closest to, but greater than the drop out width of the measured lines stored in the database. For example, the dropout width for clear X may be 700 nm. In this case, the closest dropout widths stored in the database are 725 nm and 675 nm. A dropout width of 725 nm has a corresponding PSF of 500 nm and a dropout width of 675 nm has a corresponding PSF of 450. Therefore, in this example, PSF_W_MIN is 450 and PSF_W_MAX is 500, and the PSF 1/e² for a dropout width of 700 nm may be equal to 475 nm.

In one example, the drop out width for different PSF sizes may be calculated (e.g., previously), and drop out values associated with specific PSF sizes may be stored in a database. PSF size may then be calculated as described above using the values stored in the database.

At S308, a filter may be constructed. For example, a temporary calibration file may be stored in a memory. The calibration file may include, for example, header information, a PSF in the x and y directions, PSF angle, filter parameters such as coefficient k, thresholds threshXclear, threshYclear, threshXdark, threshYdark and threshglobal, and critical dimension offsets clearCDoffset and darkCDoffset for both polarities. Parameters MinD and MaxD used in converting 3D images to 2D images may also be included in the calibration file. At step S309, the filter may be applied to stored 3D intensity images. When calibrating, a number of calibration marks may be measured. Each of at least a portion of the calibration marks may be measured in sequence and stored in a memory of the system computer. Another portion of the calibration marks may not be used during calibration, but may be used to verify the result of the calibration. In at least this example embodiment, different set of 3D images (S316) may be used for calibration and verification. Doing so may help avoid sub-optimization.

At S310, linearity curves for x and y lines may be calculated. Similar to that as discussed above, linearity curves may be the difference between CD values. For example, at S310, the linearity curves may be the difference between the measured CD value and the real or actual CD value (CDₘₑₐₛ−CD_{actual}), and the difference may be plotted with respect to the y-axis, whereas the actual linewidth may be plotted on the x-axis. In this example, CD_{actual} may be obtained by measuring the patterns using a measurement system with relatively high resolution. At S312, the calibration module may check whether the calibration is OK (e.g., whether given dropout widths are within given specifications). When checking if the calibration is OK, linearity curves may be calculated for an x and y oriented raster (e.g., Clear/dark and/or isolated/dense). According to at least some example embodiments, for all measured images, if the difference between a CD for the calculated linearity curves and a nominal CD value is less than a threshold value for line widths larger than a specific value, then the calibration is OK. For example, if the difference between a CD for the calculated linearity curves and a nominal CD value is less than about 30 nm for line widths greater than about 1 μm, the calibration is OK. Otherwise, the calibration is not OK, and the given dropout widths are not within given specifications. If at S312, the calibration is not OK, the process may re-calibrate the filter at S314. To recalibrate the filter, new partial derivatives may be determined. After recalibrating the filter, the process may return to S309, and repeat.

Returning to S312, if the calibration is OK, data not part of the calibration may be filtered at S316, and the data may be checked at S318. The data check performed at S318 may be the same as the above-described data check performed at S312. For example, linearity curves may be calculated for an x and y oriented raster (e.g., Clear/dark and isolated/dense). Subsequently, for all measured images, if the difference between a CD for the calculated linearity curves and a nominal CD value is less than a threshold value for line widths greater than a specific value, the data check passes. For example, if the difference between a CD for the calculated linearity curves and a nominal CD value is less than about 30 nm for line widths larger than about 1 μm, the data check passes. Otherwise, the data check fails. If at S318, the data check fails, the process may proceed to step S314 and repeat. Returning to S318, if the filtered data passes the check, a permanent calibration file may be stored in a memory at S320.

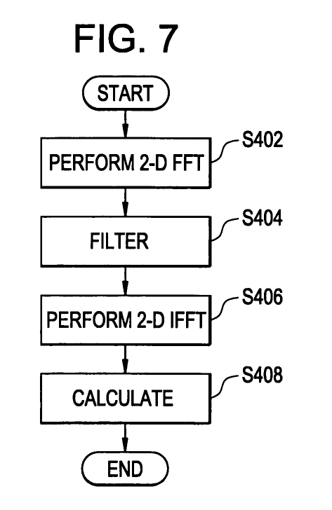

Referring back to FIG. 5, after the filter has been constructed at S206, the 3D intensity image may be filtered at S208. FIG. 7 is a flow chart illustrating a method for filtering the 3D intensity image, according to an example embodiment of the present invention, which will be discussed in more detail below.

Referring to FIG. 7, at S402, the 2D Fourier transform of the 3D intensity image may be calculated. At S404, the imaginary product (element wise) of the 2D Fourier transformed 3D intensity image and the imaginary filter function Filter may be calculated to generate a filtered 3D intensity image FILT_INT_IMAGE. The filtered 3D intensity image FILT_INT_IMAGE may be saved in a memory. At S406, an inverse 2D Fourier transform of the filtered 3D intensity image FILT_INT_IMAGE may be calculated. At S408, the absolute value of the inverse 2D Fourier transformed imaginary product may be calculated.

According to example embodiments of the present invention, the filtering at S208 and shown in FIG. 7 may enable the use of the same threshold for all line widths and/or provide the same or substantially the same relative difference from the nominal critical dimension for all line widths.

Returning to FIG. 5, at S210, the absolute value of the inverse 2D Fourier transform of the filtered 3D intensity image FILT_INT_IMAGE may be converted into a 2D image. The result may be output as a 2D image with improved resolution. This 2D image with improved resolution may be measured with greater accuracy.

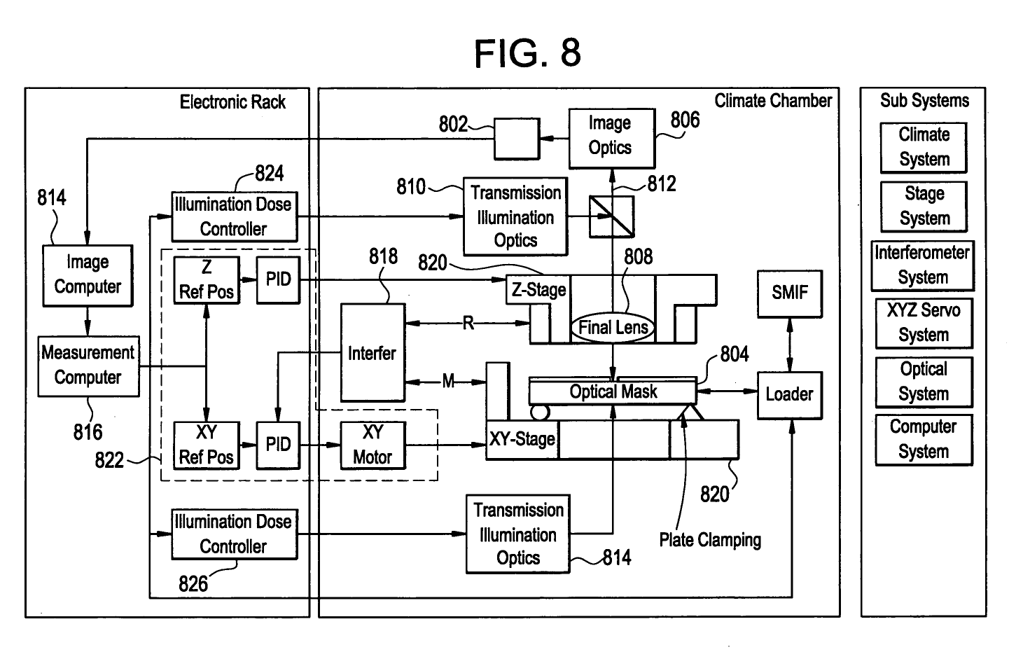

FIG. 8 illustrates an optical system, according to another example embodiment. In this example embodiment, an image is recorded using an image sensor 802 (e.g., a CCD or CMOS camera). In this example embodiment, the object 804 is illuminated by a light source such as an excimer laser having a wavelength of about 193 nm, and an image is formed on the image sensor 802 through the final lens 808 and the image optics 806. The illumination light has alternative paths to the object 804. For example, the illumination light may have an alternative path incident from the reflex illumination optics 810 on same side as the image sensor 802 for forming an image using reflected light 812, or from the transmitted illumination optics 814 on the opposite side of the reflex illumination optics 210. If the object is transparent, the reflected and transmitted modes may be used in connection with the same object. In addition, the reflected and transmitted modes may be used sequentially or simultaneously. The image or images may be fed to an image computer 814 and then the captured image data may be fed to a measurement computer 816.

Still referring to FIG. 8, the object 804, shown as a mask, may be placed on an interferometrically (labeled and referred to herein as “interfer” 818 in FIG. 8) controlled XY-stage 820 and an autofocus system 822 may change the focus plane relative to the mask plane. The autofocus system 822 may also change the physical distance between the final lens 808 and the image sensor 802 by moving the final lens 808 using a z-stage 820. Alternatively, focus may be changed by changing the refractive properties in the light path between the final lens 808 and image sensor 802. Illumination dose controllers 824 and 826 control illumination doses for the reflex illumination optics 810 and the transmission illumination optics 814, respectively. The example system shown in FIG. 8 uses a pulsed excimer laster (not shown) having a repetition rate of about 2000 flashes per second. In one example operation, the XY-stage 820 may be stationary while a series of flashes are incident and integrated on the image sensor 802 to produce a suitable number of detected photons, and at the same time average out flash-to-flash illumination variations, mechanical vibration and other disturbances. More elaborate exposure schemes with multiple exposures (e.g., images read out from the image sensor) with multiple flashes for each exposure may be used to further augment signal-to-noise.

Example embodiments of the present invention may be implemented, in software, for example, as any suitable computer program. For example, a program in accordance with one or more example embodiments of the present invention may be a computer program product causing a computer to execute one or more of the example methods described herein: a method for processing 3-D data collected by an optical system.

The computer program product may include a computer-readable medium having computer program logic or code portions embodied thereon for enabling a processor of the apparatus to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

These programs may also be provided in the form of an externally supplied propagated signal and/or a computer data signal (e.g., wireless or terrestrial) embodied in a carrier wave. The computer data signal embodying one or more instructions or functions of an example methodology may be carried on a carrier wave for transmission and/or reception by an entity that executes the instructions or functions of the example methodology. For example, the functions or instructions of the example embodiments may be implemented by processing one or more code segments of the carrier wave, for example, in a computer, where instructions or functions may be executed for improving optical resolution, in accordance with example embodiments of the present invention.

Further, such programs, when recorded on computer-readable storage media, may be readily stored and distributed. The storage medium, as it is read by a computer, may enable the improving of optical resolution, in accordance with the example embodiments of the present invention.

Example embodiments of the present invention being thus described, it will be obvious that the same may be varied in many ways. For example, the methods according to example embodiments of the present invention may be implemented in hardware and/or software. The hardware/software implementations may include a combination of processor(s) and article(s) of manufacture. The article(s) of manufacture may further include storage media and executable computer program(s), for example, a computer program product stored on a computer readable medium.

The executable computer program(s) may include the instructions to perform the described operations or functions. The computer executable program(s) may also be provided as part of externally supplied propagated signal(s). Such variations are not to be regarded as departure from the spirit and scope of the example embodiments of the present invention, and all such modifications as would be obvious to one skilled in the art are intended to be included within the scope of the following claims.

Although specific aspects may be associated with specific example embodiments of the present invention, as described herein, it will be understood that the aspects of the example embodiments, as described herein, may be combined in any suitable manner.

Although example embodiments are discussed herein with respect to metrology, example embodiments are equally useful in other applications of pulse polarized laser light, including for example, inspection, repair exposure of photomasks and wafers, etc.

Moreover, example embodiments may be equally applicable to any conventional optical system, for example, a conventional optical system, a coherent conventional optical system, etc.

While example embodiments of the present invention have been particularly shown and described, it will be understood by those of ordinary skill in the art that various changes in form and details may be made therein without departing from the spirit and scope of the present invention as defined by the following claims.

What is claimed is:

1. A method for improving optical resolution, the method comprising:
generating a three-dimensional intensity image for an object to be measured;
constructing a filter using a mathematical model of an optical system;
filtering the intensity image using the constructed filter; and
converting the three-dimensional intensity image into two-dimensional image to be measured.

2. The method of claim 1, wherein the three-dimensional intensity image is generated based on image data gathered by the optical system.

3. The method of claim 2, wherein the constructing of the filter further includes,
generating at least one threshold value based on the gathered image data,
estimating a point spread function based on the gathered image data and the at least one threshold,
constructing the filter based on the estimated point spread function and the image data, and
calibrating the constructed filter.

4. The method of claim 3, wherein the calibrating further includes,
filtering a first portion of the image data to generate a first filtered data,
measuring the linearity of the first filtered data,
determining whether the linearity of the first filtered data passes a linearity threshold, and
re-calibrating the constructed filter if the first filtered data does not pass the linearity threshold.

5. The method of claim 4, wherein if the linearity of the first filtered data passes the linearity threshold, the calibrating further includes,
determining whether the constructed filter is calibrated properly; and wherein
the image data is filtered using the constructed filter if the constructed filter is calibrated properly.

6. The method of claim 5, wherein the determining whether the constructed filter is calibrated properly further includes,
filtering a second portion of the image data to generate a second filtered data, and
comparing the second filtered data with a filter threshold to determine whether the constructed filter is calibrated properly.

7. The method of claim 6, wherein the constructed filter is calibrated properly if the second filtered data passes the filter threshold.

8. The method of claim 1, wherein the constructed filter is an inverse filter.

9. A method for measuring lithographic features on a surface of an object, the method comprising:
impinging a illumination optical beam over lithographic features on the surface;
forming an image of the lithographic features, wherein the image is created using the illumination optical beam;
filtering the image using a filter, the filter being an inverse convolution based on a kernel representing the optical system.

10. The method according to claim 9, wherein the filtering provides a threshold that is equal for all line widths and provides the same relative difference from the nominal critical dimension for all line widths.

11. The method according to claim 9, wherein the surface is a wafer or a work piece.

12. The method according to claim 9, wherein the illumination optical beam is reflected on said surface.

13. The method according to claim 9, wherein the illumination optical beam is transmitted through said surface.

14. The method according to claim 9, wherein said image is recorded on an image sensor.

15. The method according to claim 14, wherein the image sensor is at least one CCD camera or at least one CMOS camera.

16. The method according to claim 9, wherein said illumination optical beam is scanned over the lithographic features on said surface.

17. The method according to claim 9, wherein there is essentially no relative motion between said image sensor and said surface.

18. The method according to claim 9, wherein said illumination optical beam is a laser beam.

19. The method according to claim 9, wherein said image is created by at least one flash of said illumination optical beam over the lithographic features on said surface.

20. An apparatus comprising:
an optical system configured to generate a three-dimensional intensity image for an object to be measured; and
a computer configured to,
construct a filter using a mathematical model of the optical system,
filter the intensity image using the constructed filter, and
convert the three-dimensional intensity image into two-dimensional image to be measured.

21. An apparatus for measuring lithographic features on a surface of an object, the apparatus comprising:
an optical system configured to,
impinge an illumination optical beam over lithographic features on the surface to form an image of the lithographic features, the image being created using the illumination optical beam; and
a computer configured to filter the image using a filter, the filter being an inverse convolution based on a kernel representing the optical system.
